(19) United States
(12) Patent Application Publication
(10) Pub. No.: US 2009/0064563 A1
(43) Pub. Date: Mar. 12, 2009

(54) Casting and throwing tool for center pin fishing reel

(76) Inventor: Richard D. Carlin, Windsor, NY (US)

Correspondence Address: Mark Levy;HINMAN, HOWARD & KATTELL, LLP, 80 Exchange Street, P.O. Box 5250, BINGHAMTON, NY, 13901, US

(21) Appl. No.: 11/900,407

(22) Filed: Sep. 11, 2007

(51) Int. Cl. A01K 97/00

(52) U.S. Cl. 43/4

(57) ABSTRACT

A casting and throwing tool for center pin fishing reels. A ring or molded handle allows an angler to control the tool. The fishing line is strung through an open loop connected to the ring or handle. The angler can use the open loop to control the cast much easier than other techniques used for center pin fishing reels. Using the tool, a user can guide the line to the fishing pole more efficiently due to less restriction from the open loop than encountered using hand techniques. The tool prevents injuries such as cuts caused by the friction of the line.

### FIELD OF THE INVENTION

The invention pertains to fishing and, more particularly, to a tool that assists in casting and controlling center pin fishing reels.

### BACKGROUND OF THE INVENTION

Sport fishing is a large industry in the United States with nearly $5 billion spent annually on equipment, $15 billion on trips and nearly $20 billion more on boats, licenses, and other equipment. Much of this money is spent by novice anglers or people who go fishing only a few times a year. They like to try out new techniques and tools and are willing to spend money to enjoy the sport. Many types of tools are available for each facet of sport fishing.

One growing trend is the method of center pin fishing. Center pin fishing is a method of delivering a presentation to a fish in a natural, drag-free manner. It pre-dates fly fishing, and originated in Europe where fish in rough water are highly desired. Stealth and proper presentation of bait or lure is important to fish that are easily spooked. Center pin reels are simple and make for a good tool to make a long cast, or to catch long drifts in rivers. The center pin reel is a large drum with a free spinning spool that rotates in any direction. It is a type fly reel, similar to that in U.S. Pat. No. 6,412,724, with a larger diameter (usually about 5″) but a major difference is that the spool is free-spinning. Usually bearings or bushings are created around the stem to facilitate this motion. If a center pin reel handle is given a whirl, the spool will continue to spin around for minutes.

This type of fishing works well in rough water and rivers because it allows bait to flow with the current, this allowing for a more natural presentation. While center pin fishing has many benefits, it is difficult to master. Many people have trouble controlling the reel. The main method for controlling the line is palming, a technique of applying friction from the user's palm to the line in order to prevent the line from getting away when a fish is on the hook. While this technique of palming works well, the difficulty of mastering outweighs the benefits.

What is needed is a mechanism to help guide the line. This would make the technique of center pin fishing much easier to learn. There is a need for this tool so the novice angler can learn quickly and enjoy the sport but also so the experienced user can be more efficient.

### SUMMARY OF THE INVENTION

In accordance with the present invention, there is provided a metal, plastic, or rubber loop. The loop is attached to a ring made of an appropriate material including but not limited to metal, plastic, or rubber. The ring is worn on the hand. In an alternative design, the loop may be attached to a handheld piece which can be molded and floatable. The fishing line is strung through the loop, which is not entirely closed, so as to allow the fishing line to slide in and out. This design allows an angler to better control the fishing line coming from a center pin reel.

In both designs, the loop attached to the ring or to the handheld device, the loop may be attached using a universal joint, allowing the loop to turn at any angle.

It is an object of this invention to make center pin reel casting easier.

It is another object of this invention to make controlling the fishing line easier.

It is furthermore an object of this invention to prevent injuries caused by the friction of fishing line on the hand.

It is also an object of this invention to allow more people the ability to enjoy center pin reel fishing.

It is another object of this invention to make center pin fishing more enjoyable to the novice angler.

### BRIEF DESCRIPTION OF THE DRAWINGS

A more complete understanding of the present invention may be obtained by reference to the accompanying drawings, when considered in conjunction with the subsequent detailed description, in which:

FIG. 1a is a perspective view of the preferred embodiment of the invention;

FIG. 1b is a perspective view of an alternative embodiment of the invention; and

FIG. 2 is a perspective view of another alternative embodiment of the invention.

### DETAILED DESCRIPTION OF THE PREFERRED EMBODIMENT

This invention provides a relatively inexpensive tool to increase the enjoyment of center pin reel fishing by aiding in casting and throwing. The tool can be either handheld or worn as a ring and is available in different sizes to meet the needs of various users. The tool consists of but is not limited to, six primary components: (1) a loop for the fishing line, (2) a hole to slide the line in and out, (3) a universal joint to allow the loop to rotate 360 degrees, (4) a ring to wear on a finger in order to control the tool, (5) an optional floatable molded handle, and (6) a small loop on the handle for retractable line.

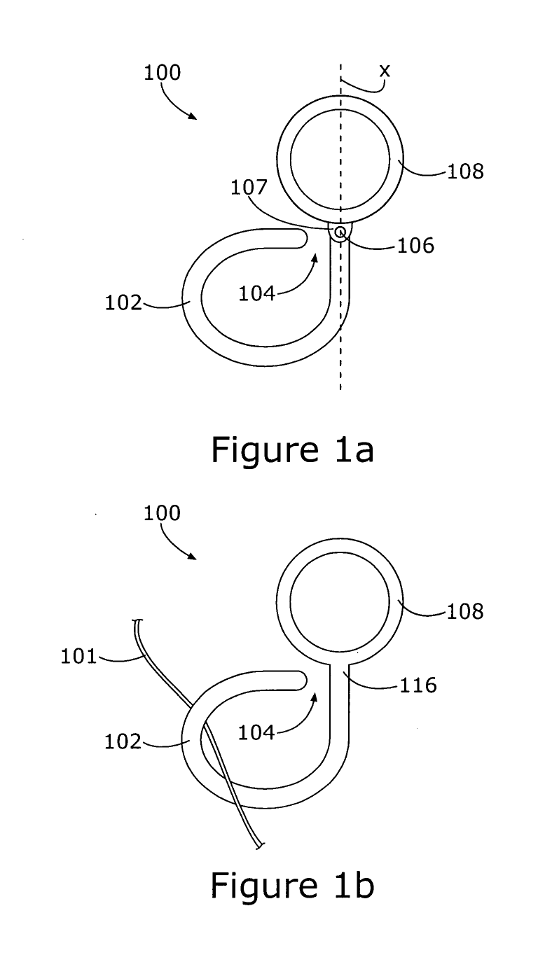

In the preferred embodiment of the inventive tool 100 shown in FIG. 1a, loop 102 is attached to a ring 108 via a protrusion 107 and a universal joint 106. Ring 108 is made in different sizes in order to fit different sized fingers. Ring 108 is made of metal, plastic, or rubber but may be made of another material familiar to those skilled in the art.

Universal joint 106 allows loop 102 to rotate 360 degrees about axis X. Universal joint 106 is optional. Some users may prefer a different type of attachment such as a rigid attachment 116, without a universal joint, shown in FIG. 1b, for connecting ring 108 to loop 102. In fact, tool 100 can also be manufactured in a single, unitary piece.

Referring still to FIGS. 1a and 1b, loop 102 has an opening 104 to allow a fishing line 101 to slide in and out of loop 102. This opening 104 is a suitable size for the fishing line 101 to slide in and is not limited to one size. More than one size opening 104 is anticipated due to the fact that fishing line 101 may be of different diameters. Depending upon the resiliency of the material used to fabricate loop 102, opening 104 may be enlarged or reduced, as required

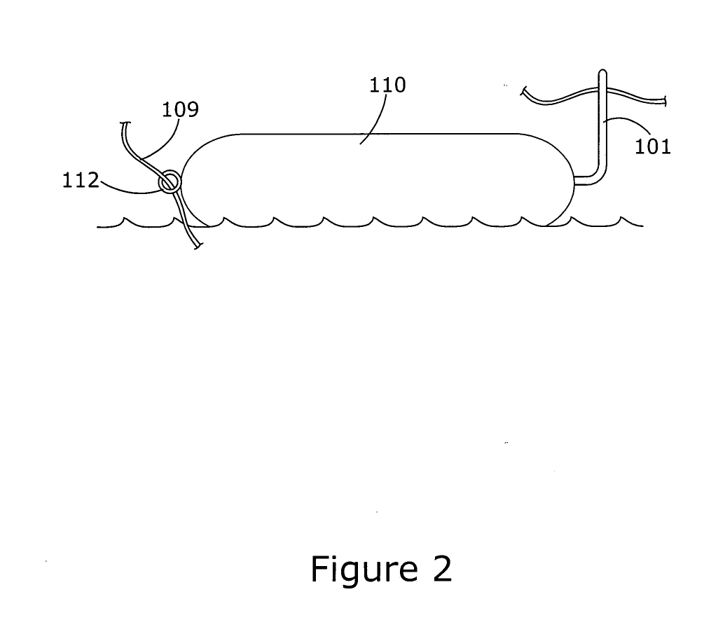

Referring now to FIG. 2, in an alternative embodiment a molded, floatable handle 110 is provided for controlling fishing line 101. Handle 110 is made of foam, plastic, or rubber but may be made of another material familiar to those skilled in the art. Molded floatable handle 110 is an alternative to the finger-worn ring 108 (FIG. 1). Handle 110 serves the same purpose as ring 108: to allow an angler to control fishing line 101.

A small loop 112 is attached to one side of handle 110. Small loop 112 is a complete, closed loop, made of metal, plastic, rubber or another material familiar to those skilled in the art. Small loop 112 is used to attach a retractable line 109 to handle 110. Retractable line 109 could be attached then to a belt or some other part of the angler, not shown, so as to secure the handle 110 and prevent loss thereof.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An article for aiding anglers in casting and controlling fishing line from a center pin fishing reel, the article comprising:
a) a ring having a periphery and sized sufficiently large to accommodate a finger of a user; and
b) an open loop connected, at a first end thereof, to said ring on a portion of said periphery thereof.

2. The article in accordance with claim 1, wherein said article comprises at least one of: rubber, plastic, metal, alloy, fiberglass, and ceramic.

3. The article in accordance with claim 1, wherein said loop comprises a second end proximate said portion of said ring periphery so that fishing line may be directed into said loop prior to casting.

4. An article for aiding anglers in casting and controlling fishing line from a center pin fishing reel, the article comprising:
a) a ring having a periphery and sized sufficiently large to accommodate a finger of a user, said ring having a protrusion extending from said periphery; and
b) an open loop connected, at a first end thereof, to said ring at said protrusion thereof.

5. The article in accordance with claim 4, wherein said article comprises at least one of: rubber, plastic, metal, alloy, fiberglass, and ceramic.

6. The article in accordance with claim 4, wherein said loop comprises a second end proximate said portion of said ring periphery so that fishing line may be directed into said loop prior to casting.

7. The article in accordance with claim 4, further comprising:
c) a universal joint disposed between said protuberance and said loop, so that said loop may rotate up to 360 degrees.

8. An article for aiding anglers in casting and controlling fishing line from a center pin fishing reel, the article comprising:
a) a handle having a plurality of indentations to accommodate a hand of a user, said handle having a first and a second end;
b) an open loop connected, at a first end thereof, to said first end of said handle; and
c) a closed loop connected to said second end of said handle to accommodate a retractable line.

9. The article in accordance with claim 8, wherein said article comprises at least one of: rubber, plastic, metal, alloy, fiberglass, and ceramic.

10. The article in accordance with claim 8, wherein said loop comprises a second end proximate a portion of said handle so that fishing line may be directed into said open loop prior to casting.
